(19) United States
(12) Patent Application Publication
(10) Pub. No.: US 2015/0298366 A1
(43) Pub. Date: Oct. 22, 2015

(54) METHOD OF MAKING PRECISION-MOLDED ARTICLES BY POLYMERIZING ETHYLENICALLY-UNSATURATED MATERIALS IN A MOLD USING IONIZING RADIATION

(71) Applicant: 3M INNOVATIVE PROPERTIES COMPANY, Saint Paul, MN (US)

(72) Inventors: Karl B. Richter, St. Paul, MN (US); Sasha B. Myers, Arden Hills, MN (US); Daniel J. O'Neal, St. Paul, MN (US); Thu-Van T. Tran, Maplewood, MN (US); Craig E. Hamer, Woodbury, MN (US)

(73) Assignee: 3M INNOVATIVE PROPERTIES COMPANY, Saint Paul, MN (US)

(21) Appl. No.: 14/648,055

(22) PCT Filed: Dec. 6, 2013
(86) PCT No.: PCT/US2013/073456

§ 371 Date: May 28, 2015

Related U.S. Application Data
(60) Provisional application No. 61/737,231, filed on Dec. 14, 2012.

(51) Int. Cl. B29C 35/08; G02B 1/04

(52) U.S. Cl. CPC B29C 35/0866; G02B 1/04; G02B 1/041; G02B 1/045; B29K 2033/08

(57) ABSTRACT

Methods of (co)polymerizing ethylenically-unsaturated materials, including the steps of providing a mixture of free radically (co)polymerizable ethylenically-unsaturated material in a mold, exposing the mixture in the mold to a source of ionizing radiation for a time sufficient to initiate (co)polymerization of at least a portion of the free radically (co)polymerizable ethylenically-unsaturated material, and allowing the free radically (co)polymerizable ethylenically-unsaturated material to (co)polymerize in the mold while continuing to expose the mixture to the source of ionizing radiation for a time sufficient to yield an at least partially (co)polymerized (co)polymer. The ethylenically-unsaturated materials are selected from vinyl-functional monomers, vinyl-functional oligomers, vinyl-functional macromers, and combinations thereof. The mixture is preferably free of thermally-induced or UV-induced free radical polymerization initiators. The source of ionizing radiation may be a gamma ray source, an x-ray source, an electron beam source with an emission energy greater than 300 keV, and combinations thereof.

### CROSS REFERENCE TO RELATED APPLICATIONS

This application claims the benefit of U.S. Provisional Application No. 61/737,231, filed Dec. 14, 2012, the disclosure of which is incorporated by reference herein in its entirety.

### FIELD

This invention relates to a method of radiation polymerizing ethylenically-unsaturated materials, more particularly, vinyl-functional monomers and oligomers in a mold, using ionizing radiation including gamma rays, x-rays, and/or high energy electron beam radiation.

### BACKGROUND

Molded articles are well known and commonly used. Molded articles having delicate structures formed therein or thereon can be challenging to mold and to subsequently process and handle. Molding small delicate articles, such as precision optical elements, is typically accomplished by injecting a molten thermoplastic (co)polymer into a mold cavity, applying additional heat to the molten thermoplastic (co)polymer while in the mold cavity for a time sufficient to allow the molten (co)polymer to flow into the small crevices within the mold cavity, and subsequently cooling the mold to allow the molten (co)polymer to solidify within the mold cavity, thereby forming an injection molded article.

Thermoplastic (co)polymers formed by (co)polymerizing (meth)acrylic monomers and which are solid at room temperature are particularly desirable for use in precision molding applications, as they are generally inexpensive, and can be formulated to exhibit a softening or processing temperature well above room temperature but not so high as to require excessive heating during processing. Such (co)polymers can be produced by bulk free-radical polymerization in a batch reactor under essentially adiabatic reaction conditions (see, for example, U.S. Pat. No. 5,986,011). U.S. Pat. No. 4,810,523 describes a method for producing hot melt (co)polymers in which a polymerizable monomer composition is introduced into a sealable reaction vessel and polymerized by ionizing radiation. The (co)polymer is then removed from the reaction vessel before hot melt application. The reaction vessel may be a lined cylindrical pressure vessel or a multilayer bag.

### SUMMARY

In view of the foregoing, we recognize that there is a need for methods of making precision molded articles comprising (co)polymers of ethylenically-unsaturated materials, suitable for use as optical elements, wherein the (co)polymerization takes place in a mold. The (co) polymerization process takes place in the absence of thermal initiators or photoinitiators, using a source of ionizing radiation in the (co)polymerization process. The (co)polymerization may take place either adiabatically or non-adiabatically, with or without de-aeration of the reaction mixture.

Thus, in one aspect, the present disclosure provides methods of free radically (co)polymerizing ethylenically-unstaturated materials to form molded articles, including the steps of (a) providing a mixture of free radically (co)polymerizable ethylenically-unsaturated material in a mold, (b) exposing the mixture in the mold to a source of ionizing radiation for a time sufficient to initiate (co)polymerization of at least a portion of the free radically (co)polymerizable ethylenically-unsaturated material, and (c) allowing the free radically (co)polymerizable ethylenically-unsaturated material to (co)polymerize while continuing to expose the mixture to the source of ionizing radiation for a time sufficient to yield an at least partially (co)polymerized (co)polymer. In some exemplary embodiments of the foregoing methods, the mixture can be non-heterogeneous.

In certain exemplary embodiments of any of the foregoing methods, the mixture is substantially free of thermally-induced or UV-induced free radical (co)polymerization initiators. In additional exemplary embodiments of any of the foregoing methods, the source of ionizing radiation is selected from a gamma ray source, an x-ray source, an electron beam source having an emission energy of greater than 300 keV, and combinations thereof.

In some particular exemplary embodiments, the (co)polymer comprises a (meth)acrylic (co)polymer. Preferably, the ethylenically-unsaturated materials are selected from vinyl-functional monomers, vinyl-functional oligomers, vinyl-functional macromers, and combinations thereof.

In another aspect, the disclosure describes a precision molded article made according to any of the preceding (co)polymerization methods using a mold. In some exemplary embodiments, the precision molded article is a molded optical element selected from the group consisting of a mirror, a lens, a prism, a light pipe, a light guide, a diffraction grating, a lighting element, or a combination thereof. In certain exemplary embodiments, the precision molded article exhibits at least one beneficial characteristic selected from the group consisting of a substantial absence of birefringence, a substantial absence of residual stresses, a substantial absence of sink marks, a substantial absence of knit marks, a substantial absence of weld lines, a substantial absence of voids, or a combination thereof.

### Listing of Exemplary Embodiments

In some exemplary embodiments of any of the foregoing methods, the reaction mixture is deaerated by sparging with an inert gas to reduce oxygen levels prior to entering the mold. In further exemplary embodiments of any of the foregoing methods, the mixture is exposed to ionizing radiation for a time sufficient to receive a dose of ionizing radiation up to 100 kiloGray.

In some particular exemplary embodiments of the foregoing methods, the ethylenically-unsaturated materials are comprised of vinyl-functional monomers. In certain such embodiments, the vinyl-functional monomers are comprised of of monofunctional unsaturated (meth)acrylate esters of a non-tertiary alkyl alcohol, wherein the non-tertiary alkyl alcohol comprises an alkyl group containing from 1 to about 30 carbon atoms, more preferably 1 to 18 carbon atoms. In certain such embodiments, monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, octadecyl acrylate, methyl acrylate, ethyl acrylate, butyl acrylate, methyl methacrylate, N-butyl methacrylate, 2-methyl butyl acrylate, and mixtures thereof. In some particular embodiments, the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

In certain embodiments of any of the foregoing methods, the mixture further comprises a chain transfer agent. In some such embodiments, the chain transfer agent is selected from the group consisting of carbon tetrabromide, hexanebromoethane, bromotrichloromethane, ethanethiol, isooctylthioglycoate, 2-mercaptoethanol, 3-mercapto-1,2-propanediol, 2-butyl mercaptan, n-octyl mercaptan, t-dodecylmercaptan, 2-ethylhexyl mercaptopropionate, 2-mercaptoimidazole, 2-mercaptoethyl ether, cumene, ethyl acetate, ethanol, 2-propanol, and combinations thereof. In certain such embodiments, the concentration of the chain transfer agent in the mixture is from 0.01% to 20% by weight, based upon the total weight of the mixture. In some particular such embodiments, the concentration of the chain transfer agent in the mixture is no more than about 0.2% by weight, based upon the total weight of the mixture.

In some exemplary embodiments of any of the foregoing methods, the mixture has a concentration of the free radically (co)polymerizable ethylenically-unsaturated monomers less than 3% by weight of the total weight of the mixture at the completion of step (c). In certain such exemplary embodiments, the mixture has a concentration of the free radically (co)polymerizable ethylenically-unsaturated material less than 1% by weight of the total weight of the mixture at the completion of step (c). In other exemplary embodiments of any of the foregoing methods, the mixture has a gel content less than 10% by weight, based on the total weight of the mixture, at the completion of step (c). In some exemplary embodiments, the optical activity of the at least partially (co)polymerized (co)polymer is substantially identical to that of the mixture comprising free radically (co)polymerizable ethylenically-unsaturated monomers.

### Unexpected Advantages of Some Exemplary Embodiments

The various processes and methods of the present disclosure, in some exemplary embodiments, advantageously provide a continuous or semi-continuous, high-throughput (co)polymerization process useful in making precision molded optical elements. The (co)polymers may be polymerized in novel form factors for use as (co)polymer light guides, optical fibers, lenses, prisms, polarizers, diffraction gratings, and the like; or may be (co)polymerized in bulk and hot-melt processed in an injection molding process to form a precision molded optical element with minimal residuals or extractables. (Co)polymer properties may be tailored by altering total dose, dose rate, additives, and temperature without affecting optical quality.

Preferred processes of the present disclosure do not make use of chemical initiators, e.g. thermal initiators and/or photoinitiators, to initiate (co)polymerization. In contrast, thermally- or photo-initiated free radical (co)polymerization generally leaves in the (co)polymerization product a fraction of the residual initiator and initiator fragments which can cause haze, and which may yellow over time. In contrast, the use of ionizing radiation to initiate (co)polymerization generally does not require the addition of a polymerization initiator, as the ionizing radiation itself initiates (co)polymerization. Thus, (co)polymerization using ionizing radiation produces a cleaner reaction product with less haze and yellowing.

Furthermore, the absence of initiators makes the optical activity (absorbance of light) of the final (co)polymer substantially identical to that of the mixture of ethylenically-unsaturated material used as the starting point in the (co)polymerization process, and thus the resulting (co)polymers are generally optically inert and/or optically clear. In some exemplary embodiments, the resulting (co)polymer may be a liquid optically clear (co)polymer.

Thus, another advantage associated with use of ionizing radiation to initiate (co)polymerization includes the potential to produce clean and clear (co)polymers suitable for use in precision optical elements for use in optical applications. Use of ionizing radiation during the (co)polymerization process tends to graft lower molecular weight species to larger polymer networks, reducing residual levels of undesirable extractable materials, such as residual monomers, and other undesirable by-products. Shrinkage of the precision molded element may also be reduced.

Various aspects and advantages of exemplary embodiments of the present disclosure have been summarized. The above Summary is not intended to describe each illustrated embodiment or every implementation of the present disclosure. The Detailed Description that follows more particularly exemplifies certain presently preferred embodiments using the principles disclosed herein.

### DETAILED DESCRIPTION

Precision optical elements (e.g. lenses, mirrors, prisms, beam splitters, polarizers, diffraction gratings, light pipes, and the like) are used in a wide variety of industrial and consumer products. For example, precision optical elements are a key component in electronic display devices (e.g., liquid crystal displays and projectors, televisions, computer monitors, e-readers, cellular phones, MP3 players, and the like). Driven by a desire to reduce both weight and manufacturing cost of such devices, manufacturers have recently turned to using optical elements formed of molded plastic material in place of the heavier and more expensive glass optical components traditionally used in such light management applications.

One of the major challenges in the production of precision molded plastic optical elements is the need to meet high standards in molding precision and quality in order to achieve the desired product performance requirements in advanced light management applications. Common practices for injection molding of plastic optical parts typically involve using methods such as coining, injection compression, variothermal response molding, slow servo driven plastic injection, and/or combinations thereof. Such practices are useful in molding simple optical elements, such as screens, diffraction gratings, and some simple lenses or mirrors.

Over the past decade, however, the complexity in optics has evolved from predominantly flat or slightly curved optical surfaces to ones having a significant amount of compound curvature along with thick and thin wall sections which limit the applicability or usage of such techniques. Furthermore, optical parts now have significantly tighter dimensional tolerance specifications that preclude several of these well-known techniques from even being considered.

The present disclosure describes precision molding methods useful in fabricating precision molded plastic optical components, for example, an optical light guide. Although an optical light guide is used as an exemplary precision molded plastic optical element throughout this disclosure, it will be understood that the methods and apparatus described herein may be advantageously applied to produce other precision optical elements (e.g., lenses, mirrors, prisms, polarizers, diffraction gratings, lighting elements, and the like).

(Meth)acrylic (co)polymers could be particularly useful for forming low cost, lightweight precision molded optical elements. However, (meth)acrylic (co)polymers are typically synthesized using a chemical initiator—one that is blended into a monomer mixture and then activated at elevated temperature or by exposure to visible/ultraviolet light. These thermal and photo-initiators can be expensive, and the residual initiator or initiator fragments remaining after (co)polymerization can adversely affect (co)polymer performance over time. Using gamma radiation as the initiation source, we eliminate the need for added chemical initiators.

Initiator-free compositions are especially useful for two broad classes of (co)polymers: optically clear (co)polymers (OCAs) and low VOC/FOG (co)polymers (those with low organic emissions). The absence of initiator in ionizing radiation (co)polymerized (co)polymer compositions makes them as optically clear (and/or optically inert) as their component ethylenically-unsaturated raw materials, generally exhibiting high light transmission, low haze, and low yellowness. The initiator and fragments can also contribute to the adhesive's volatile organic compounds (VOC) or FOG emissions. These components are especially problematic, as they are not easily removed by vacuum during extrusion.

Gamma radiation induces (co)polymerization by directly ionizing the monomer mixture, generating free radicals from which propagation can occur. The depth of penetration and low dose rate of gamma photons are ideal for creating high molecular weight (co)polymers, as initiation occurs throughout the bulk and at a low enough frequency to allow time for long-chain growth. Gamma radiation produces radicals statistically on all species present: difficult-to-polymerize monomers, existing polymer chains, and any other monomers or additives. Thus, incorporation of ethylenically-unsaturated materials with lower reactivity is possible, and short chains can be grafted into a larger polymer network. Ultimately, more highly-branched, multi-functional, lower-residual (co)polymers can be produced than with chemical initiators.

For ionizing radiation (co)polymerized (co)polymers, the (co)polymer properties may be tailored by changing total dose or dose rate (quantity and frequency of free radical generation), rather than relying on compositional changes alone. For example, higher total dose will produce a more cross-linked (co)polymer, even in the absence of multi-functional monomers. A higher dose rate can generate (co)polymers with higher short-branch content, virtually impossible using standard thermal or photo-initiators.

Although dose can be useful for small adjustments, tailoring (co)polymer properties using dose alone can be a challenge. Target doses must be high enough to ensure nearly complete monomer conversion, but not so high as to cross-link the polymer network—typically ˜4 kGy. At low levels of chain transfer agent (CTA), i.e., those typical for traditional UV or thermally-initiated systems, this window is fairly small—1 or 2 kGy. One to two kGy precision is not difficult to attain in an experimental capacity, but would pose a large challenge on a manufacturing scale. By incorporating large quantities of CTA (2-6 times traditional levels), we have greatly expanded the range of acceptable dose, creating a robust operational process window suitable for a continuous manufacturing process. We are able to produce highly converted, low gel (co)polymers at doses of 4.5 to >45 kGy.

For typical UV- or thermally-initiated polymerizations, formulations containing high quantities of CTA would produce short-chain (co)polymers with poor performance. Any short chain produced will persist in the final composition, unless, of course, it goes through another transfer event (unlikely). With gamma (co)polymerization, short chains are not “dead”. Initiation events occur randomly on the short chains and longer ones, and those free-radicals can combine or provide a site for additional monomer incorporation. Thus, through gamma (co)polymerization, we create high molecular weight, branched (co)polymer structures by combining short chains, longer ones, and monomer. These and other unexpected results and advantages of various processes of the present disclosure are described in detail below.

Throughout the specification, the recitation of numerical ranges by endpoints includes all numbers subsumed within that range (e.g. 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### GLOSSARY

Certain terms are used throughout the description and the claims that, while for the most part are well known, may require some explanation. It should understood that, as used herein:

The terms “about” or “approximately” with reference to a numerical value or a shape means +/− five percent of the numerical value or property or characteristic, but expressly includes the exact numerical value. For example, a temperature of “about” 100° C. refers to a temperature from 95° C. to 105° C., but also expressly includes a temperature of exactly 100° C.

The term “substantially” with reference to a property or characteristic means that the property or characteristic is exhibited to a greater extent than the opposite of that property or characteristic is exhibited. For example, a process that is “substantially” adiabatic refers to a process in which the amount of heat transferred out of a process is the same as the amount of heat transferred into the process, with +/−5%.

The terms “a”, “an”, and “the” include plural referents unless the content clearly dictates otherwise. Thus, for example, reference to a material containing “a compound” includes a mixture of two or more compounds.

The term “or” is generally employed in its sense including “and/or” unless the content clearly dictates otherwise.

The term “homogeneous” means exhibiting only a single phase of matter when observed at a macroscopic scale.

The term “non-heterogeneous” means “substantially homogeneous”

The terms “(co)polymer” or “(co)polymers” includes homopolymers and copolymers, as well as homopolymers or copolymers that may be formed in a miscible blend, e.g., by co-extrusion or by reaction, including, e.g., transesterification. The term “(co)polymer” includes random, block and star (e.g. dendritic) (co)polymers.

The term “(meth)acrylate” with respect to a monomer, oligomer or means a vinyl-functional alkyl ester formed as the reaction product of an alcohol with an acrylic or a methacrylic acid.

The term “liquid optically clear (co)polymer composition” means a liquid optically clear (co)polymer (LOCA) or a precursor composition which may be cured to form a LOCA.

The term “glass transition temperature” or “T_{g}” refers to the glass transition temperature of a (co)polymer when evaluated in bulk rather than in a thin film form. In instances where a (co)polymer can only be examined in thin film form, the bulk form T_{g} can usually be estimated with reasonable accuracy. Bulk form T_{g} values usually are determined by evaluating the rate of heat flow vs. temperature using differential scanning calorimetry (DSC) to determine the onset of segmental mobility for the (co)polymer and the inflection point (usually a second-order transition) at which the (co)polymer can be said to change from a glassy to a rubbery state. Bulk form T_{g} values can also be estimated using a dynamic mechanical thermal analysis (DMTA) technique, which measures the change in the modulus of the (co)polymer as a function of temperature and frequency of vibration.

The term “molecularly same (co)polymer(s)” means (co)polymer(s) that have essentially the same repeating molecular unit, but which may differ in molecular weight, method of manufacture, commercial form, and the like.

The term “cross-linked” (co)polymer refers to a (co)polymer whose molecular chains are joined together by covalent chemical bonds, usually via cross-linking molecules or groups, to form a network (co)polymer. A cross-linked (co)polymer is generally characterized by insolubility, but may be swellable in the presence of an appropriate solvent.

As defined herein, by “essentially adiabatic” it is meant that total of the absolute value of any energy exchanged to or from the reaction mixture during the course of reaction will be less than about 15% of the total energy liberated due to reaction for the corresponding amount of (co)polymerization that has occurred during the time that (co)polymerization has occurred. Expressed mathematically, the essentially adiabatic criterion (for monomer poltmerization) is:

$${{\int }^{{t}_{2}}}_{{t}_{1}} {\sum }_{j = 1}^{N} \vert {q}_{j} ( t ) \vert d t \leq f \cdot {{\int }^{{x}_{2}}}_{{x}_{1}} Δ {H}_{p} ( x ) d x \qquad ( 1 )$$

where f is about 0.15, ΔHₚ is the heat of (co)polymerization, x=monomer conversion=(M_{O}-M)/M_{O} where M is the concentration of the monomer and M_{O} is the initial monomer concentration, x₁ is the (co)polymer fraction at the start of the reaction and x₂ is the (co)polymer fraction due to (co)polymerization at the end of the reaction, t is the time. t₁ is the time at the start of reaction, t₂ is the time at the end of reaction, and qⱼ(t), wherein j=1 . . . N is the rate of energy transferred to the reacting system from the surroundings from all N sources of energy flow into the system.

Examples of energy transfer sources for qⱼ(t), wherein j=1 . . . N include, but are not limited to, heat energy conducted to or from the reaction mixture from the reactor jacket, energy required to warm internal components in the reaction equipment such as the agitator blades and shaft, and work energy introduced from mixing the reacting mixture. In the practice of the present disclosure, having f as close to zero as possible is preferred to maintain uniform conditions within a reaction mixture during a reaction (that is, maintain homogeneous temperature conditions throughout a reaction mixture) which helps to minimize batch-to-batch variations in a particular piece of equipment as well as minimize batch-to-batch variations when reactions are made in batch reactors of differing sizes (that is, uniform scale up or scale down of reaction).

With reference to a mold, the term “feature” means a three dimensional cavity, recess, or depression within a mold cavity that may define, at least in part, the shape of an article to be molded, such as a prism or lens.

### Exemplary Process Embodiments

Various exemplary embodiments of the present disclosure will now be described. Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

In exemplary embodiments, the present disclosure provides processes for free radically (co)polymerizing ethylenically-unsaturated material using a source of ionizing radiation, substantially in the absence of thermal initiators and any non-reactive diluents. The processes include (a) providing a mixture comprising free radically (co)polymerizable ethylenically-unsaturated material in a mold; (b) exposing the mixture in the mold to a source of ionizing radiation for a time sufficient to initiate (co)polymerization of at least a portion of the free radically (co)polymerizable ethylenically-unsaturated material, and (c) allowing the free radically (co)polymerizable ethylenically-unsaturated material to (co)polymerize in the mold while continuing to expose the mixture to the source of ionizing radiation for a time sufficient to yield an at least partially (co)polymerized (co)polymer.

In other exemplary embodiments, the present disclosure provides processes for free radically (co)polymerizing vinyl-functional monomers, vinyl-functional oligomers, or a combination thereof, using a source of ionizing radiation, substantially in the absence of thermal initiators, optionally in the presence of a nanoparticulate filler that can remain in the (co)polymer product.

In certain exemplary embodiments of any of the foregoing processes, the mixture can be non-heterogeneous or homogeneous. In certain exemplary embodiments of any of the foregoing processes, the mixture is substantially free of thermally-induced or UV-induced free radical (co)polymerization initiators. In additional exemplary embodiments of any of the foregoing processes, the source of ionizing radiation is selected from a gamma ray source, an x-ray source, an electron beam source having an emission energy of greater than 300 keV, and combinations thereof.

### Free Radically (Co)polymerizable Ethylenically-unsaturated Materials

The ethylenically-unsaturated materials suitable for use in practicing exemplary methods of the present disclosure are generally selected from vinyl-functional monomers, vinyl-functional oligomers, vinyl-functional macromers, and combinations thereof.

Vinyl-Functional Monomers

A variety of free radically (co)polymerizable monomers can be used according to the method of the present disclosure. Thus, in some exemplary embodiments, the free radically (co)polymerizable ethylenically-unsaturated material is comprised of vinyl-functional monomers, more preferably, vinyl-functional (meth)acrylate monomers.

The identity and relative amounts of such components are well known to those skilled in the art. Particularly preferred among (meth)acrylate monomers are alkyl (meth)acrylates, preferably a monofunctional unsaturated acrylate ester of a non-tertiary alkyl alcohol, wherein the alkyl group contains 1 to about 30 carbon atoms, more preferably 1 to 18 carbon atoms. Included within this class of monomers are, for example, isooctyl acrylate, isononyl acrylate, 2-ethylhexyl acrylate, decyl acrylate, dodecyl acrylate, n-butyl acrylate, hexyl acrylate, octadecyl acrylate, 2-methyl butyl acrylate, and mixtures thereof.

In some presently preferred embodiments, the monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, octadecyl acrylate, methyl acrylate, ethyl acrylate, butyl acrylate, methyl methacrylate, N-butyl methacrylate, 2-methyl butyl acrylate, and mixtures thereof.

In certain exemplary embodiments, the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

Optionally and preferably in preparing a PSA, polar (co)polymerizable monomers can be (co)polymerized with the (meth)acrylate monomers to improve adhesion of the final (co)polymer composition to metals and also improve cohesion in the final (co)polymer composition. Strongly polar and moderately polar (co)polymerizable monomers can be used.

Strongly polar (co)polymerizable monomers include but are not limited to these selected from the group consisting of (meth)acrylic acid, itaconic acid, hydroxyalkyl acrylates, cyanoalkyl acrylates, acrylamides, substituted acrylamides, and mixtures thereof. A strongly polar (co)polymerizable monomer preferably constitutes a minor amount, for example, up to about 25 weight % of the monomer, more preferably up to about 15 weight %, of the monomer mixture. When strongly polar (co)polymerizable monomers are present, the alkyl acrylate monomer generally constitutes a major amount of the monomers in the acrylate-containing mixture, for example, at least about 75% by weight of the monomers.

Moderately polar (co)polymerizable monomers include, but are not limited to, those selected from the group consisting of N-vinyl pyrrolidone, N,N-dimethyl acrylamide, acrylonitrile, vinyl chloride, diallyl phthalate, and mixtures thereof. A moderately polar (co)polymerizable monomer preferably constitutes a minor amount, for example, up to about 40 weight %, more preferably from about 5 weight % to about 40 weight %, of the monomer mixture. When moderately polar (co)polymerizable monomers are present, the alkyl acrylate monomer generally constitutes at least about 60 weight % of the monomer mixture.

Vinyl-Functional Oligomers and Macromers

Macromonomers (macromers) are another ethylenically-unsaturated material useful in certain embodiments of the present disclosure. Described in U.S. Pat. No. 4,732,808 is the use of free-radically (co)polymerizable macromonomers having the general formula X—(Y)ₙ—Z wherein:
X is a vinyl group (co)polymerizable with other monomer(s) in the reaction mixture;
Y is a divalent linking group; where n can be zero or one; and
Z is a monovalent (co)polymeric moiety having a glass transition temperature, T_{g}, greater than about 20° C., and a weight average molecular weight in the range of about 2,000 to about 30,000 and being essentially unreactive under (co)polymerization conditions.

These macromonomers are generally used in mixtures with other (co)polymerizable monomer(s). A preferred macromonomer described in U.S. Pat. No. 4,732,808 can be further defined as having an X group which has the general formula:

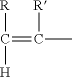

wherein R is a hydrogen atom or a —COOH group and R′ is a hydrogen atom or methyl group. The double bond between the carbon atoms provides a (co)polymerizable moiety capable of (co)polymerizing with the other monomer(s) in the reaction mixture.

A preferred macromonomer includes a Z group which has the general formula:

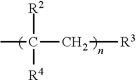

wherein R² is a hydrogen atom or a lower alkyl group (typically C₁ to C₄), R³ is a lower alkyl group (typically C₁ to C₄), n is an integer from 20 to 500 and R⁴ is a monovalent radical selected from the group consisting of:

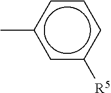

and —CO₂R⁶ wherein R⁵ is a hydrogen atom or a lower alkyl group (typically C₁ to C₄) and R⁶ is a lower alkyl group (typically C₁ to C₄).

Preferably, the macromonomer has a general formula selected from the group consisting of:

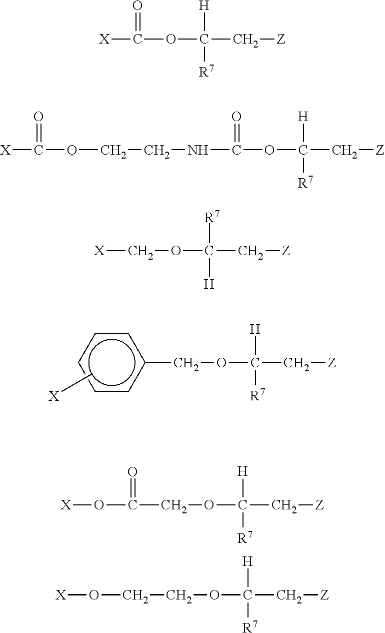

wherein R⁷ is a hydrogen atom or lower alkyl group (typically C₁ to C₄).

Preferred macromonomers are functionally terminated (co)polymers having a single functional group (the vinyl group) and are sometimes identified as “semitelechelic” (co)polymers. (Vol. 27 “Functionally Terminal Polymers via Anionic Methods” D. N. Schultz et al., pages 427-440, Anionic Polymerization, American Chemical Society [1981]). Such macromonomers are known and may be prepared by the methods disclosed by Milkovich et al. in U.S. Pat. Nos. 3,786,116 and 3,842,059. As disclosed therein, vinyl terminated macromonomer is prepared by anionic (co)polymerization of (co)polymerizable monomer to form a living (co)polymer. Such monomers include those having an olefinic group, such as the vinyl-containing compounds. Living (co)polymers are conveniently prepared by contacting the monomer with an alkali metal hydrocarbon or alkoxide salt in the presence of an inert organic solvent which does not participate in or interfere with the (co)polymerization process. Monomers which are susceptible to anionic (co)polymerization are well known. Illustrative species include vinyl aromatic compounds such as styrene, alpha-methyl styrene, vinyl toluene and its isomers or non-aromatic vinyl compounds such as methyl methacrylate. Other monomers susceptible to anionic (co)polymerization are also useful.

The purpose of using a (co)polymerizable macromonomer includes but is not limited to enabling hot-melt coating of the PSA, for example, by increasing the cohesive strength of the cooled extruded sheet PSA, e.g. by the interaction of the pendant Z moieties on the (co)polymer backbone. The amount of macromonomer used is generally within the range of about 1% to about 30%, preferably about 1% to about 7%, of the total weight of monomers. The optional use of such macromonomers is included within the scope of the present disclosure. A particular advantage of some exemplary embodiments of the present disclosure is the ability to successfully (co)polymerize said macromonomers into the (co)polymer backbone.

### Optional Materials

Various optional materials may be added to the reaction mixture used in the processes of the present disclosure before, during, or after any one or more of step (a), (b), and/or (c). Some optional materials, such as chain transfer agents, cross-linkers, photoinitiators, and the like, may react with one or more of the ethylenically-unsaturated material in the reaction mixture, and are preferably added to the reaction mixture before step (a), during step (a), during step (b), during step (c), or a combination thereof.

Optional Chain Transfer Agent(s)

Chain transfer agents, which are well known in the (co)polymerization art, may also be included in any of the processes of the present disclosure, for example, to control the molecular weight or other (co)polymer properties. The term “chain transfer agent” as used herein also includes “telogens.” Suitable chain transfer agents for use in exemplary methods of the present disclosure include but are not limited to those selected from the group consisting of carbon tetrabromide, hexanebromoethane, bromotrichloro-methane, ethanethiol, isooctylthioglycoate, 2-mercaptoethanol, 3-mercapto-1,2-propanediol, 2-butyl mercaptan, n-octyl mercaptan, t-dodecylmercaptan, 2-ethylhexyl mercaptopropionate, 2-mercaptoimidazole, 2-mercaptoethyl ether, cumene, ethyl acetate, ethanol, 2-propanol, and combinations thereof.

Depending on the reactivity of a particular chain transfer agent and the amount of chain transfer desired, typically from 0.01% to 25% by weight of chain transfer agent is used, based upon the total weight of ethylenically-unsaturated (co)polymerizable material used in the mixture. More preferably, from about 0.025 wt. % to about 20.0 wt. % of chain transfer agent is used, based upon the total weight of ethylenically-unsaturated (co)polymerizable material used in the mixture. Most preferably, from about 0.04 wt. % to about 15 wt. % of chain transfer agent is used, based upon the total weight of ethylenically-unsaturated (co)polymerizable material used in the mixture.

Optional Crosslinker(s)

Cross-linking may also be used in the processes of the present disclosure. For example, in the art of hot-melt PSA manufacture, PSAs often require a curing step after they have been extruded in sheet form in order to give them good bond strength and toughness. This step, known as post curing, usually comprises exposing the extruded sheet to some form of radiant energy, such as electron beam, or ultraviolet light with the use of a chemical cross-linking agent.

Thus, one or more crosslinker(s) may be may be added to the reaction mixture used in the processes of the present disclosure before, during, or after any one or more of step (a), (b), and/or (c). Examples of suitable cross-linking agents or cross-linkers include but are not limited to those selected from the groups consisting of hydrogen abstraction type photo-cross-linkers such as those based on benzophenones, acetophenones, anthraquinones, and the like. These cross-linking agents can be (co)polymerizable or non-(co)polymerizable.

Examples of suitable non-(co)polymerizable hydrogen abstraction cross-linking agents include benzophenone, anthraquinones, and radiation-activatable cross-linking agents such as those described in U.S. Pat. No. 5,407,971. Such agents have the general formula:

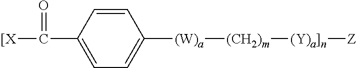

wherein W represents —O—, —N—, or —S—; X represents CH₃— or phenyl; Y represents a ketone, ester, or amide functionality; Z represents a polyfunctional organic segment that contains no hydrogen atoms more photo-abstractable than hydrogen atoms of a (co)polymer formed using the cross-linking agent; m represents an integer from 0 to 6; “a” represents 0 or 1; and n represents an integer 2 or greater. Depending on the amount of cross-linking desired and the efficiency of the particular cross-linker used, non-(co)polymerizable cross-linking agents are typically included in the amount of about 0% to about 10%, and preferred in the range of about 0.05% to about 2%, based on the total weight of the ethylenically-unsaturated material (e.g., monomers).

Examples of suitable (co)polymerizable hydrogen abstraction cross-linking compounds include mono-ethylenically-unsaturated aromatic ketone monomers free of orthoaromatic hydroxyl groups.

Examples of suitable free-radically (co)polymerizable cross-linking agents include but are not limited to those selected from the group consisting of 4-acryloxybenzophenone (ABP), para-acryloxyethoxybenzophenone, and para-N-(methacryloxyethyl)-carbamoylethoxy-benzophenone. (Co)polymerizable chemical cross-linking agents are typically included in the amount of about 0% to about 2%, and preferred in the amount of about 0.025% to about 0.5%, based on the total weight of monomer(s). Other useful (co)polymerizable cross-linking agents are described in U.S. Pat. No. 4,737,559.

Optional Nanoparticulates

In additional exemplary embodiments of any of the foregoing processes, the mixture may further include a population of inorganic nanoparticulates having a population median particle diameter of less than one micrometer. In some such exemplary embodiments, the inorganic nanoparticulates are metal oxide particulates selected from titanium dioxide, aluminum oxide, silicon dioxide, indium oxide, tin oxide, zinc oxide, zirconium oxide, and combinations thereof. Nanoparticulate calcium carbonate may also be used. The inorganic nanoparticulates may be distributed, preferably homogeneously distributed, in the mixture before, during, or after completion of the polymerization step, or combinations thereof.

Appropriate amounts of filler will be familiar to those skilled in the art, and will depend upon numerous factors including, for example, the monomer(s) utilized, the type of filler, and the end use of the (co)polymer product. Typically, filler will be added at a level of about 1% to about 50% by weight (preferably, about 2 wt. % to about 30 wt. %; more preferably about 3 wt. % to about 20 wt. %), based upon the total weight of the reaction mixture or finished (co)polymer material.

Optional (Co)Polymer(s)

Optionally, one or more (co)polymer(s) can be dissolved in the reaction mixture prior to the first essentially adiabatic reaction cycle. Alternatively and/or additionally, the optional (co)polymer(s) may be included in subsequent essentially adiabatic reaction cycles. Such (co)polymer(s) may be included to modify the molecular weight distribution, molecular weight, or properties of the final (co)polymer product after reacting is complete and generally will be non-reactive during the (co)polymerization of the inventive process. The use of (co)polymer syrups to make (meth)acrylic (co)polymers is explained, for example, in U.S. Pat. No. 4,181,752.

Although it is not required, the (co)polymer generally will be comprised of, or otherwise compatible with, the same ethylenically unsaturated materials as those used in the reaction mixture. Preferably, the (co)polymer(s) are compatible with the monomer(s), oligomer(s), macromer(s), optional chain transfer agent(s), optional cross-linker(s), and the like, added to the reaction mixture.

The optional (co)polymer(s) added to the reaction mixture is typically added in an amount from at least about 1% to at most about 50% by weight; at least about 3 wt. % to at most about 30 wt. %; or at least about 5 wt. % to at most about 20 wt. %, based on the total weight of the reaction mixture or finished (co)polymer material.

### Ionizing Radiation Sources

In exemplary embodiments of the present disclosure, a source of ionizing radiation is used to initiate polymerization of the mixture of ethylenically-unsaturated material. Any conventional source of penetrating ionizing radiation may be employed, i.e., any source of low LET (linear energy transfer) radiation which is capable of extracting protons from the monomers to create free radicals which propagate to form (co)polymer chains. The known types of ionizing radiation include, for example, gamma rays and X-rays. Thus, the source of ionizing radiation may be a gamma ray source, an x-ray source, an electron beam source with an emission energy greater than 300 keV, and combinations thereof.

It is presently preferred to employ gamma radiation as the ionizing radiation. Suitable sources of gamma radiation are well known and include, for example, radioisotopes such as cobalt-60 and cesium-137. Generally, suitable gamma ray sources emit gamma rays having energies of 400 keV or greater. Typically, suitable gamma ray sources emit gamma rays having energies in the range of 500 keV to 5 MeV. Examples of suitable gamma ray sources include cobalt-60 isotope (which emits photons with energies of approximately 1.17 and 1.33 MeV in nearly equal proportions) and cesium-137 isotope (which emits photons with energies of approximately 0.662 MeV). The distance from the source can be fixed or made variable by changing the position of the target or the source. The flux of gamma rays emitted from the source generally decays with the square of the distance from the source and duration of time as governed by the half-life of the isotope.

Once a dose rate has been established, the absorbed dose is accumulated over a period of time. During this period of time, the dose rate may vary if the mold is in motion or other absorbing objects pass between the source and sample. For any given piece of equipment and irradiation sample location, the dosage delivered can be measured in accordance with ASTM E-1702 entitled “Practice for Dosimetry in a Gamma Irradiation Facility for Radiation Processing”. Dosimetry may be determined per ASTM E-1275 entitled “Practice for Use of a Radiochromic Film Dosimetry System” using GEX B3 thin film dosimeters.

Thus, in certain exemplary embodiments, the reaction mixture in the mold is exposed to ionizing radiation for a time sufficient to receive a dose of ionizing radiation up to 100 kiloGray, up to 90 kiloGray, up to 80 kiloGray, up to 70 kiloGray, up to 60 kiloGray, or up to 50 kiloGray. In further exemplary embodiments, the mixture is exposed to ionizing radiation for a time sufficient to receive a dose of ionizing radiation of at least 5 kiloGray, at least 10 kiloGray, at least 20 kiloGray, at least 30 kiloGray, at least 40 kiloGray, or even at least 50 kiloGray.

### Molds

The (co)polymerization of the ethylenically-unsaturated material is carried out on the reaction mixture in a mold. The mold may be a precision mold having an internal cavity corresponding to a desired precision optical component. The mold may be unitary (one piece), or may be separable into multiple pieces which form an internal cavity when assembled. The mold preferably has at least one inlet communicating with the cavity for introducing the reaction mixture into the mold. The mold may be open or, more preferably, sealed during the (co)polymerization process. The mold may be made of any number of materials, including metal, glass, silicone, polyethylene, TEFLON™, and combinations thereof. Exemplary molds are described in U.S. Pat. Nos. 4,022,855; 5,015,280; and 5,329,406.

In some embodiments, the mold may have an internal cavity having a shape corresponding to a desired molded article, more particularly, a precision molded optical element. In some exemplary embodiments, the precision molded article is a molded optical element selected from the group consisting of a mirror, a lens, a prism, a light pipe, a light guide, a diffraction grating, a lighting element, or a combination thereof.

A batch reaction may be used advantageously in practicing the methods of the present disclosure. By reacting batch wise it is meant that the (co)polymerization reaction occurs in a mold where the molded article is removed at the end of the reaction. The reaction mixture is preferably added to the mold at one time prior exposure to the source of ionizing radiation. The reaction is allowed to proceed for the necessary amount of time to achieve, in this case, (co)polymer properties including the desired (co)polymerization amount, molecular weight, etc.

For small-scale non-precision molding, the mold can be advantageously selected to be a sealable container, such as a sealable vial, bottle, flask, can, pail, and the like. Sealable glass containers are presently preferred, although plastic or metal containers may also be used. Preferably, the sealed container or mold is placed in a temperature control apparatus, for example, a water bath, cold box, refrigerator, and the like. Preferably, the temperature control apparatus is used to pre-cool the reaction mixture prior to exposure of the reaction mixture to the source of ionizing radiation.

In some embodiments, the reaction mixture is sealed in a container mold, preferably a cylindrical container having a diameter of from about 0.5 in. (1.27 cm) to about 30 in. (76.2 cm), and then the preferably cylindrical container can be rotated about its center axis of symmetry, with the center axis parallel to the source of radiation, in order to obtain more uniform irradiation by minimizing attenuation by the contents. For example, gamma ray attenuation of about 20% occurs at the axis of a 10-in. (25.4 cm) diameter cylindrical container, and such non-uniformity is generally acceptable.

### Polymerization Methods

Typical reaction(s) with the inventive process proceed as follows. The monomer(s) are charged to the mold in the desired amount(s). The temperature of the reaction vessel must be cool enough so that virtually no thermal (co)polymerization of the monomer(s) will occur and also cool enough so that virtually no (co)polymerization will occur when the initiator(s) are added to the reaction mixture. Also, care should be taken to ensure the reactor is dry, in particular, free of any undesired volatile solvent (such as reactor cleaning solvent), which potentially could dangerously elevate the pressure of the reaction vessel as the temperature increases due to heat of (co)polymerization. The optional photoinitiator(s), optional non-reactive diluents(s), optional nanoparticle filler(s), optional chain transfer agent(s), optional cross-linking agent(s), optional (co)polymer(s), optional organic solvent(s), etc., are also charged to the reactor.

In some exemplary methods of the present disclosure, the reaction mixture need not be de-aerated before or during steps (a)-(c) of the process. In other exemplary methods, the reaction mixture is deaerated before step (a). Deaeration (i.e., de-oxygenation) procedures are well known to those skilled in the art of free-radical (co)polymerization. For example, deaeration may typically be accomplished by bubbling (i.e. sparging) an inert gas such as nitrogen through the reaction mixture to displace dissolved oxygen.

Prior to exposing the reaction mixture in the mold to a source of ionizing radiation, it may be desirable to pre-cool the reaction mixture as described above. However, it is presently preferred that the reaction mixture not be cooled during steps (a)-(c), so that the (co)polymerization process may be carried out under substantially adiabatic conditions, more preferably adiabatic conditions.

In certain embodiments of the processes of the present disclosure, the reaction mixture in the mold is exposed to the source of ionizing radiation for only a short period of time at the beginning of step (b) sufficient to initiate the (co)polymerization reaction. In such embodiments, it may be desirable not to expose the reaction mixture to the source of ionizing radiation during all or a portion of step (c). In such embodiments, the exposure time to the source of ionizing radiation in steps (b) and/or (c) may be advantageously varied from about 1 minute to about 120 minutes, from about 5 min. to about 60 min., from about 10 min. to about 30 min., or even from about 15-20 min. In other embodiments, it may be desirable to expose the reaction mixture to the source of ionizing radiation for the entirety of step (b) and/or step (c). In such embodiments, the exposure time to the source of ionizing radiation in steps (b) and/or (c) may be advantageously varied from about 10 minutes to about 24 hours, from about 20 min. to about 12 hours, from about 30 min. to about 6 hours, or even from about 1 hour to about 3 hours.

(Co)polymerization can be carried out over a wide range of dose rates in the range of a kilorad per second to about a kilorad per hour. It is generally preferred, however, that the dose rate be kept between from 5 to about 500 kilorads per hour, between from about 10 to about 400 kilorads per hour, or even from about 20 to about 250 kilorads per hour. Dose rates below 1 kilorad per hour may result in polymers with molecular weights too high to be useful due to low tack and (co)polymer failure. Dose rates exceeding a few tenths of a kilorad per second may result in (co)polymers of too low molecular weight to be useful as (co)polymers due to cohesive failure or low creep resistance. However, some (co)polymer formulations produced above this range may find application in specialty products. In other cases, these low molecular weight (co)polymers may subsequently be cross-linked to provide sufficient cohesion.

Some exemplary processes of the present disclosure allow for careful control of both molecular weight and molecular weight distribution in the final (co)polymer, thereby allowing the practitioner to “tailor” the properties of the resulting (co)polymer, (co)polymer, pressure-sensitive (co)polymer, or hot melt pressure sensitive (co)polymer. Several variables can be manipulated to control the molecular weight of the final product, the most important being radiation dose rate and concentration of chain transfer agent.

Unlike the chemically initiated polymerization procedures of the prior art, in which the rate of chain initiation (and consequently molecular weight) is highly temperature dependent, the polymerization procedure of the present disclosure is relatively unaffected by temperature, except in reaction mixtures where chain transfer is an important factor. Consequently, limitations on the ability to remove heat from the reactants do not interfere substantially with the ability to control molecular weight in the processes of the present disclosure.

Although temperature is relatively less important in controlling molecular weight in the process of the present disclosure than in chemically initiated (co)polymerizations, it may nevertheless be a significant factor in compositions having relatively high chain transfer to monomer coefficients such as 2-ethylhexyl acrylate and N-vinyl pyrrolidone or for compositions having relatively high concentrations of chain transfer agent. For such compositions, temperature, as well as dose rate, can be varied to obtain the desired molecular weight, with increasing temperature resulting in lower molecular weight. Thus, dose rate, chain transfer agent concentration and temperature can all be used, separately or in combination, to control molecular weight.

In low-solvent or solventless bulk (co)polymerizations, such as those preferably used to produce the exemplary molded articles of the present disclosure, molecular weight can be controlled effectively by manipulation of composition, dose rate, and initial temperature since the viscosity buildup in the reaction mixture makes the removal of heat and control of reaction temperature difficult.

The molecular weight distribution can be controlled by varying the dose rate in a continuous or stepwise manner during the (co)polymerization reaction. It is thus possible to produce polydisperse or polymodal molecular weight distributions which make possible the production of a wide range of products having a variety of (co)polymer and cohesive products. For example, the (co)polymerization reaction may be carried out at a first dose rate for a period of time and then the dose rate changed for the remainder of the (co)polymerization in order to produce an essentially bimodal molecular weight distribution.

The total integrated radiation dose primarily affects the degree of conversion of the ethylenically-unsaturated material to the finished (co)polymer material. In general, it is desirable to irradiate to conversions of 95% or greater and preferably to conversions of 99.5% or higher. However, the reaction rate becomes asymptotic with time as monomer concentration is depleted, and it becomes more difficult to achieve very high conversion. Low solvent or solventless reaction mixtures are presently preferred, since higher viscosity aids in monomer reaction at high conversion. Thus, solventless compositions may be polymerized using the processes of the present disclosure to very low levels of residual monomer. This is particularly important in pressure-sensitive (co)polymers used for medical applications, where even small amounts of residual monomer may irritate the skin. During the asymptotic or monomer depletion stage of the reaction, radiation cross-linking will begin to occur. Radiation induced cross-linking will be more significant as solids concentration increases. Cross-linking may be minimized by the inclusion of chain transfer agent but only at the expense of obtaining lower molecular weights for the finished (co)polymer material. There are cases where over-irradiation to achieve a degree of cross-linking may be permissible, or even desirable. Cross-links may be tolerated or even desired up to a certain density as they give greater cohesion and creep resistance.

The process may be varied to produce a wide variety of (co)polymers exhibiting a broad range of final (co)polymer properties, among them molecular weight distribution, residual monomer concentration, cross-link density, tack, shear strength, and the like. Post application of ultraviolet or ionizing irradiation may be employed to further alter properties of the (co)polymer, particularly when used as a hot melt (co)polymer. Final (co)polymer properties will depend on both polymerization and post-application processing conditions. Products containing some degree of residual monomer may be particularly useful where post application irradiation is employed.

The higher molecular weights obtainable and pre-application cross-linking make possible the production of (meth)acrylic (co)polymer (co)polymers, either in solution or solventless, which require significantly less post-application curing, by either chemical or radiation processes, than many existing products.

As previously indicated, some exemplary processes of the present disclosure may be carried out in the absence or near absence of solvent to produce bulk (meth)acrylate-based (co)polymers. As the amount of solvent in the reaction system approaches zero, reaction conditions become essentially adiabatic due to the inability to remove the heat of polymerization from the reaction mixture. Nevertheless, we have discovered that the polymerization processes of the present disclosure can be performed without de-aeration of the reaction mixture under either adiabatic or non-adiabatic conditions, without a breakdown in molecular weight or creation of a runaway reaction.

Because the (co)polymerization may be carried out essentially adiabatically, the heat of reaction released after initiation of the (co)polymerization process by exposure of the reaction mixture to the source of ionizing radiation acts to increase the temperature of the reaction mixture. The temperature of the reaction mixture rises to a peak temperature, then begins to drop as the supply of ethylenically-unsaturated material in the reaction mixture is converted to (co)polymer, and the (co)polymerization reaction(s) approach completion.

Once the reaction temperature has peaked, the (co)polymer content at this point is typically from about 30-90% by weight based on the total weight of ethylenically-unsaturated material and (co)polymer in the mold. The (co)polymerization reaction cycle can be stopped at this point. Typically, the reaction mixture temperature is cooled prior to removal of the molded article from the mold. Generally the molded article is cooled to a temperature of from about 20-40° C. before removal from the mold.

In certain exemplary embodiments, the precision molded article exhibits at least one beneficial characteristic selected from the group consisting of a substantial absence of birefringence, a substantial absence of residual stresses, a substantial absence of sink marks, a substantial absence of knit marks, a substantial absence of weld lines, a substantial absence of voids, or a combination thereof.

### EXAMPLES

These examples are merely for illustrative purposes and are not meant to be limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Materials

Table 1 presents a listing of the materials used in the Examples. All parts, percentages, ratios, and the like in the examples and the rest of the specification are by weight, unless noted otherwise. Solvents and other reagents used may be obtained from Sigma-Aldrich Chemical Company (Milwaukee, Wis.) unless otherwise noted.

TABLE 1

| Material | Chemical Composition | Source |
|---|---|---|
| AA | Acrylic Acid | BASF Florham Park, NJ |
| IOA | Isooctyl acrylate | 3M Company, St. Paul, MN |
| 2-EHA | 2-ethyl hexyl acrylate | BASF Florham Park, NJ |
| IOTG | Isooctylthioglycoate | Dow Chemical, Midland, MI |
| MMA | Methyl methacrylate | Sigma-Aldrich Chemical, |
| | | Milwaukee, WI |
| NNDMA | N,N-Dimethylacrylamide | Sigma-Aldrich Milwaukee, WI |

### Test Methods

The test methods used in the Examples are described further below.

Monomer Residuals

Monomer residuals were measured using an NIR procedure. The IR signature (wavelength and response factor) of each monomer was calibrated to absolute content, which enables quantitative measurement of residuals (in wt. %).

Gel Content

Gel content was determined by immersing the samples, enclosed in wire mesh cages, in ethyl acetate for 24 hours to extract any soluble (co)polymer chains. The percent gel reported is the portion of the total mass remaining after attempted dissolution.

### Experimental Apparatus

The experimental apparatus used to irradiate the reaction mixtures in the currently described Examples was a Nordion JS-10000 Hanging Tote Irradiator manufactured by Nordion Corp. (Ottawa, Ontario, Canada).

The irradiation with gamma rays as a source of ionizing radiation was accomplished using a source strength of 1.5 to 3 MCi from a source consisting of a series of hollow stainless steel tubes containing Co-60 (⁶⁰Co). Generally, mid-way through the dose exposure of multiple samples, the samples were retrieved from the irradiation chamber, and the relative position reversed to provide a more uniform exposure. The samples were conveyed into the irradiation chamber and exposed to gamma rays for periods of time necessary to achieve the desired dose.

Sample Preparation and Dose

Samples were generated by exposure of the monomer mixtures to gamma radiation. The dose (energy/mass) delivered to each sample was measured with B3 DoseStix radiochromic thin film dosimeters which were evaluated shortly after irradiation. The total absorbed doses ranged from 5 to 20 kGy, and dose rates were about 0.0005 to 0.005 kGy/sec.

Samples were prepared by metering the monomer mixture into a mold [e.g. a 25 g to 5-gallon (about 19.5 liter) container], with care taken to ensure the mold contained as little air as possible.

### Example 1

### 2-EHA/AA/IOTG

A monomer mixture of 96.5 wt. % 2-EHA, 3.46 wt. % AA, and 0.04 wt. % IOTG was prepared. The monomer mixture was metered to completely fill a ½ gallon can mold (about 1.95 liter), taking care to eliminate as much headspace as possible. The mold was exposed to gamma radiation to a dose of 7.6 kGy. The resulting sample had monomer residuals of 1.39 wt. %.

### Example 2

### 2-EHA/AA/IOTG

A monomer mixture of 96.5 wt. % 2-EHA, 3.38 wt. % AA, and 0.12 wt. % IOTG was prepared. The monomer mixture was metered to completely fill a ½ gallon can mold (about 1.95 liter), taking care to eliminate as much headspace as possible. The mold was exposed to gamma radiation to a dose of 6.6 kGy. The resulting sample had monomer residuals of 2.19 wt. %.

### Example 3

### IOA/IOTG

A monomer mixture of 99.88 wt. % IOA and 0.12 wt. % IOTG was prepared. The monomer mixture was metered to completely fill a pint can mold (about 487 ml), taking care to eliminate as much headspace as possible. The mold was exposed to gamma radiation to a dose of 5.4 kGy. The resulting sample had monomer residuals of 1.84 wt. %.

### Example 4

### MMA

MMA monomer was metered to completely fill a 30 g glass vial mold, taking care to eliminate as much headspace as possible. The mold was exposed to gamma radiation to a dose of 18.7 kGy. The resulting sample was a solid slug upon removal from the mold.

### Example 5

### IOA/AA/IOTG

A monomer mixture of 96.5 wt. % IOA, 3.42 wt. % AA, and 0.08 wt. % IOTG was prepared. Three gallons of the monomer mixture was metered into a 5-gallon bucket mold (about 19.5 liter). The remaining headspace was purged with 20 psi of UHP N₂ for 4 minutes to eliminate oxygen. The mold was then exposed to gamma radiation to a dose of 6.3 kGy. The resulting sample had monomer residuals of 2.68 wt. % and a gel content of 2 wt. %.

### Example 6

### 2-EHA/AA/Aerosil200/IOTG

A monomer mixture of 91.5 wt. % 2-EHA, 3.42 wt. % AA, 5 wt. % Aerosil 200, and 0.08 wt. % IOTG was prepared. The monomer mixture was metered to completely fill a ½ gallon (about 1.95 liter) can mold, taking care to eliminate as much headspace as possible. The mold was then exposed to gamma radiation to a dose of 7.4 kGy. The resulting sample had monomer residuals of 2.94 wt. % and a gel content of 1.46 wt. %.

### Example 7

### 2-EHA/AA/NNDMA/IOTG

A monomer mixture of 89.96 wt. % 2-EHA, 5 wt. % AA, 5 wt. % NNDMA, and 0.04 wt. % IOTG was prepared. Three gallons of the monomer mixture was metered into a 5-gallon gallon (about 19.5 liter) bucket mold. The remaining headspace was purged with 20 psi of UHP N₂ for 4 minutes to eliminate oxygen. The mold was then exposed to gamma radiation to a dose of 17.0 kGy. The resulting sample had monomer residuals of 2.84 wt. % and a gel content of 0.72 wt. %.

Table 2 presents a summary of the formulations and properties of the samples obtained in the Examples.

TABLE 2

| | | | | Residual | |
|---|---|---|---|---|---|
| | | | | Monomer | Gel |
| | (Co)polymer | Composition | Dose | Level | Content |
| Example | Designation | (wt %) | (kGy) | (wt %) | (wt %) |
| 1 | 2-EHA/AA/IOTG | 96.5/3.46/0.04 | 7.6 | 1.39 | — |
| 2 | 2-EHA/AA/IOTG | 96.5/3.38/0.12 | 6.6 | 2.19 | — |
| 3 | IOA/IOTG | 99.88/0.12 | 5.4 | 1.84 | 7 |
| 4 | MMA | 100 | 18.7 | — | — |
| 5 | IOA/AA/IOTG | 96.5/3.42/0.08 | 6.3 | 2.68 | 2 |
| 6 | 2-EHA/AA//IOTG/ | 91.5/3.42/0.08/5 | 7.4 | 2.94 | 1.46 |
| | Aerosil200 | | | | |
| 7 | 2-EHA/AA/NNDMA/IOTG | 89.96/5/5/0.04 | 17.0 | 2.84 | 0.72 |

### Example 8

Thin optical light guide samples were created by filling various long cylindrical molds (plastic tubes) with monomer solution and irradiating the filled molds with ionizing radiation while immersed in room temperature (23° C.) water or ice water maintained at about (2° C.). Thicker light guides were made by polymerizing liquid monomer inside glass tubes having a 1.25 inch (about 3.2 cm) diameter and an approximately 14 inch (about 35.6 cm) length. The glass tubes were lined with THV or TEFLON™ to prevent bubble formation after polymerization shrinkage and to facilitate removal easier of the molded article. The tubes were filled with a 90/10 mixtures of either IOA/AA, 2OA/AA or 2-EHA/AA monomer solution, and sealed with THV or Teflon lined rubber stoppers. The sealed tubes were immersed in ice water to provide cooling during irradiation and reaction.

Ionizing radiation induced polymerization was carried out by delivering 3.2-3.5 kGy in 80 min (2-EHA) or 3.8-3.9 kGy in 100 min (IOA, 2OA) in the irradiator. The polymerization did not increase light absorption. In fact, the low wavelength light absorption actually decreased after polymerization.

The gamma polymerized molded articles were compared to compositionally similar molded articles that were photopolymerized using 0.24 pph Irgacure 651 as a photoinitiator, and an ultraviolet curing lamp. The light absorption behavior showed significant light absorbance at small wavelengths caused by addition of the photoinitiator.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. The particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this present disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method comprising:
(a) providing a mixture comprising free radically (co)polymerizable ethylenically-unsaturated material in a mold, wherein the mixture is non-heterogeneous;
(b) exposing the mixture in the mold to a source of ionizing radiation for a time sufficient to initiate (co)polymerization of at least a portion of the free radically (co)polymerizable ethylenically-unsaturated material; and
(c) allowing the free radically (co)polymerizable ethylenically-unsaturated material to (co)polymerize in the mold while continuing to expose the mixture to the source of ionizing radiation for a time sufficient to yield an at least partially (co)polymerized (co)polymer.

2. (canceled)

3. The method of claim 1, wherein the mixture is substantially free of thermally-induced or UV-induced free radical (co)polymerization initiators.

4. The method of claim 1, wherein the source of ionizing radiation is selected from a gamma ray source, an x-ray source, an electron beam source having an emission energy of greater than 300 keV, and combinations thereof.

5. The method of claim 1, wherein the mixture is deaerated by sparging with an inert gas to reduce oxygen levels in the mixture before step (a), in step (a), in step (b), in step (c), or combinations thereof.

6. The method of claim 1, wherein the mixture further comprises a chain transfer agent.

7. The method of claim 6, wherein the chain transfer agent is selected from the group consisting of carbon tetrabromide, hexanebromoethane, bromotrichloromethane, ethanethiol, isooctylthioglycoate, 2-mercaptoethanol, 3-mercapto-1,2-propanediol, 2-butyl mercaptan, n-octyl mercaptan, t-dodecylmercaptan, 2-ethylhexyl mercaptopropionate, 2-mercaptoimidazole, 2-mercaptoethyl ether, cumene, ethyl acetate, ethanol, 2-propanol, and combinations thereof.

8. The method of any one of claim 7, wherein the concentration of chain transfer agent in the mixture is from 0.01% to 20% by weight, based upon the total weight of the mixture.

9. The method of claim 8, wherein concentration of chain transfer agent in the mixture is no more than about 0.2% by weight, based upon the total weight of the mixture.

10. The method of claim 9, wherein the mixture is exposed to ionizing radiation for a time sufficient to receive a dose of ionizing radiation up to 100 kiloGray.

11. The method of claim 1, wherein the free radically (co)polymerizable ethylenically-unsaturated material is comprised of vinyl-functional monomers, vinyl-functional oligomers, vinyl-functional macromers, or a combination thereof.

12. The method of claim 11, wherein the vinyl-functional monomers are comprised of monofunctional unsaturated (meth)acrylate esters of a non-tertiary alkyl alcohol, wherein the non-tertiary alkyl alcohol comprises an alkyl group containing from 1 to about 30 carbon atoms.

13. The method of claim 12, wherein the monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, octadecyl acrylate, methyl acrylate, ethyl acrylate, butyl acrylate, methyl methacrylate, N-butyl methacrylate, 2-methyl butyl acrylate, and mixtures thereof.

14. The method of claim 1, wherein the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

15. The method of claim 1, wherein the mixture has a concentration of the free radically (co)polymerizable ethylenically-unsaturated monomers less than 3% by weight of the total weight of the mixture, at the completion of step (c).

16. The method of claim 1, wherein the mixture has a concentration of the free radically (co)polymerizable ethylenically-unsaturated material less than 1% by weight of the total weight of the mixture, at the completion of step (c).

17. The method of claim 1, wherein the mixture has a gel content less than 10% by weight, based on the total weight of the mixture, at the completion of step (c).

18. The method of claim 1, wherein the at least partially (co)polymerized (co)polymer exhibits an optical activity substantially identical to that of the mixture comprising the free radically (co)polymerizable ethylenically-unsaturated material.

19. The method of claim 1, wherein the mold is comprised of metal, silicone, polyethylene, poly(tetrafluoroethylene), or a combination thereof.

20. A molded article prepared according to the method of claim 1, wherein the molded article is a molded optical element selected from the group consisting of a mirror, a lens, a prism, a light pipe, a light guide, a diffraction grating, a lighting element, or a combination thereof.
